(19) United States
(12) Patent Application Publication
(10) Pub. No.: US 2006/0006669 A1
(43) Pub. Date: Jan. 12, 2006

(54) Vehicle latch apparatus and method

(76) Inventors: James Nelsen, Howell, MI (US); Timothy S. O'Callaghan, Fenton, MI (US)

Correspondence Address: MICHAEL BEST & FRIEDRICH, LLP, 100 E WISCONSIN AVENUE, MILWAUKEE, WI, 53202, US

(21) Appl. No.: 10/887,248

(22) Filed: Jul. 8, 2004

(51) Int. Cl. E05C 3/06

(52) U.S. Cl. 292/216

(57) ABSTRACT

Some embodiments of the present invention provide a ratchet engagable with a striker to selectively control separation between a closure panel of a vehicle and another portion of the vehicle, and a lift lever to bias the striker away from an engaged position with the ratchet. In some embodiments, the lift lever exerts a lower amount of force upon the striker in a latched position than in an unlatched position.

### BACKGROUND OF THE INVENTION

Conventional vehicle latches prevent separation between latched elements, such as a vehicle door and door frame, a vehicle hood, trunk lid, or tonneau cover and adjacent vehicle portions, and the like. Some conventional vehicle latches also perform one or more additional functions. For example, some vehicle latches provide clearance between a hood, trunk lid, tonneau cover, or other closure panel and adjacent vehicle portions when the latch is in an unlatched state, such as in cases where user access for opening the closure panel is desired. In some applications, these latches provide resistance to the weight of a closure panel hinged about a horizontal axis.

Conventional vehicle latches are often used with or include a variety of elements and assemblies to separate a closure panel from adjacent vehicle portions when the latch is unlatched. For example, some conventional latches rely upon the force from one or more springs or other biasing elements at a hinge of the closure panel to separate the closure panel from adjacent vehicle portions when the latch is unlatched. However, due to their locations, such biasing elements typically provide relatively little mechanical advantage in separating the closure panel from adjacent vehicle portions. In cases where one or more biasing elements at the hinge are also used to assist in opening the closure panel to a fully-opened position, such biasing elements can require substantial force to close the closure panel, and can increase the force required to unlatch the latch due to increased friction between latch components. Also in such cases, the force exerted by the biasing elements typically increases as the closure panel is closed, and is greatest when the closure panel is in its closed position—a condition that is not always desirable. Although lower-strength springs or other biasing elements can instead be used, such biasing elements are often not strong enough to open the closure panel, or do so to an insufficient degree.

Other conventional vehicle latches rely upon the force from one or more springs or other biasing elements that are part of the latch or are otherwise located nearer to a free end of the closure panel. However, these latch and biasing element configurations typically have the same shortcomings as the latch and biasing element configurations described above, including higher closing forces and increased unlatching forces.

### SUMMARY OF THE INVENTION

Some embodiments of the present invention provide a vehicle latch for releasably securing a striker with respect to the latch, wherein the vehicle latch comprises a ratchet pivotable about an axis between a latched position in which the ratchet retains the striker and an unlatched position in which the striker can be removed from the ratchet; and a lever engagable with the striker and pivotable about the axis to at least assist in moving the striker from a first position with respect to the axis to a second position with respect to the axis, wherein the second position is located a greater distance from the axis than the first position.

In some embodiments of the present invention, a vehicle latch for releasably securing a striker with respect to the latch is provided and comprises a ratchet having a latched position in which separation of the striker from the ratchet is restricted and an unlatched position in which the striker can be separated from the ratchet; and a lever pivotable with respect to the ratchet, the lever biased in a pivoting direction and positioned to exert an unlatching force on the striker, the unlatching force having a first magnitude when the ratchet is in the latched position and a second magnitude when the ratchet is in the unlatched position, the second magnitude greater than the first magnitude.

Some embodiments of the present invention provide a vehicle latch for releasably securing a striker with respect to the latch, wherein the vehicle latch comprises a ratchet having a latched position in which movement of the striker is restricted by the ratchet and an unlatched position in which the striker is removable from the ratchet; a lever pivotable with respect to the ratchet, the lever engagable with the striker and pivotable to bias the striker toward a disengaged position with respect to the ratchet in the unlatched position of the ratchet, the lever having a first position when the latch is in a latched state and a second position when the latch is in an unlatched state; and a spring coupled to the lever and positioned to exert a varying torque on the lever at different positions of the lever, the torque having a first magnitude when the lever is in the first position and a second magnitude with the lever in the second position, wherein the first magnitude is smaller than the second magnitude.

In some embodiments of the present invention, a method of unlatching a vehicle latch from a striker is provided, and comprises applying a first force to a pivotable lever when the latch is in a latched state, the first force having a radial component and a tangential component with respect to an axis about which the lever is pivotable; disengaging a pawl from a ratchet; moving the ratchet from a latched position in which the ratchet restricts removal of the striker from the vehicle latch toward an unlatched state in which the striker is removable from vehicle latch; pivoting the lever; moving the striker with respect to the ratchet by pivoting the lever; and applying a second force to the lever when the latch is in an unlatched state, the second force having a radial component and a tangential component with respect to the axis, wherein the tangential component of the second force is greater than the tangential component of the first force.

Some embodiments of the present invention provide a method of unlatching a vehicle latch from a striker to release a portion of a closure panel of a vehicle from the vehicle, wherein the method comprises applying a torque to a lever while the latch is in a latched state; disengaging a pawl from a ratchet; pivoting the ratchet about a pivot from a latched position in which the ratchet restricts removal of the striker from the vehicle latch toward an unlatched position in which the striker is removable from the ratchet; pivoting the lever in a first direction after disengaging the pawl from the ratchet; increasing the torque on the lever as the lever pivots in the first direction; and moving the striker with the lever from a first distance with respect to the pivot to a second distance greater than the first distance with respect to the pivot.

In some embodiments of the present invention, a method of releasably securing a striker with respect to a vehicle latch to releasably secure a closure panel of the vehicle to the vehicle is provided, wherein the vehicle latch has an unlatched state in which the striker is insertable into the vehicle latch and a latched state in which a ratchet restricts removal of the striker from the vehicle latch, and wherein the method comprises exerting a force upon a lever by the striker while the vehicle latch is in the unlatched state; moving the striker towards a latched position of the striker; moving the lever towards a latched position of the lever by moving the striker; pivoting the ratchet from an unlatched position of the ratchet to a latched position of the ratchet; and decreasing a resistance force exerted upon the striker by the lever as the striker is moved toward the latched position of the striker.

Further aspects of the present invention, together with the organization and operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show an embodiment of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numeral indicate like parts:

FIG. 1 is a perspective view of a latch assembly according to an embodiment of the present invention, shown in a latched state engaged with a striker;

FIG. 2 is a perspective view of the latch assembly illustrated in FIG. 1, shown in an unlatched state disengaged from the striker;

FIG. 3 is an exploded perspective view of the latch assembly illustrated in FIGS. 1 and 2;

FIG. 4 is an elevational view of the latch assembly and striker illustrated in FIGS. 1-3, shown with the latch assembly in the latched state engaged with the striker;

FIG. 5 is another elevational view of the latch assembly and striker illustrated in FIGS. 1-3, shown with the latch assembly in an unlatched state;

FIG. 6 is another elevational view of the latch assembly and striker illustrated in FIGS. 1-3, shown with the latch assembly in an unlatched state and the striker moved away from the ratchet;

FIG. 7 is a planar view of a latch assembly according to another embodiment of the present invention, shown in a latched state;

FIG. 8 is a planar view of the latch assembly illustrated in FIG. 7, shown in an unlatched state;

FIG. 9 is a perspective detail view of the latch assembly illustrated in FIGS. 7 and 8, shown with the latch assembly in the latched state;

FIG. 10 is another perspective detail view of the latch assembly illustrated in FIGS. 7 and 8, shown with the latch assembly in an unlatched state; and

FIG. 11 is another perspective detail view of the latch assembly illustrated in FIGS. 7 and 8, shown with the latch assembly in an unlatched state and the striker moved away from the ratchet.

### DETAILED DESCRIPTION OF THE ILLUSTRATED EMBODIMENT

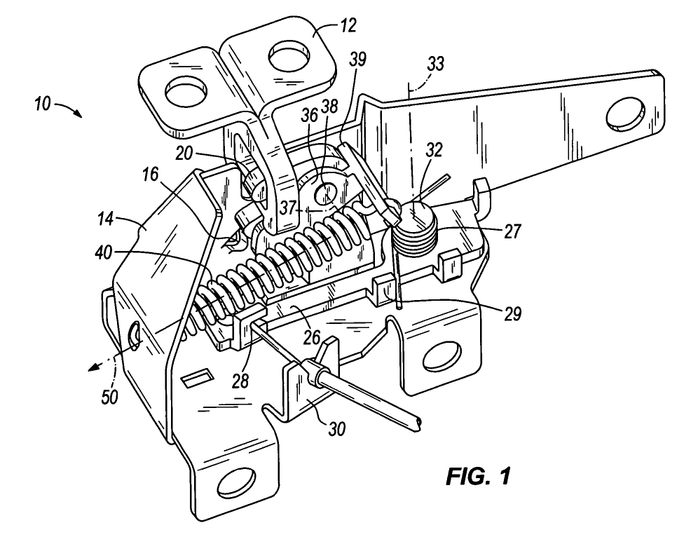

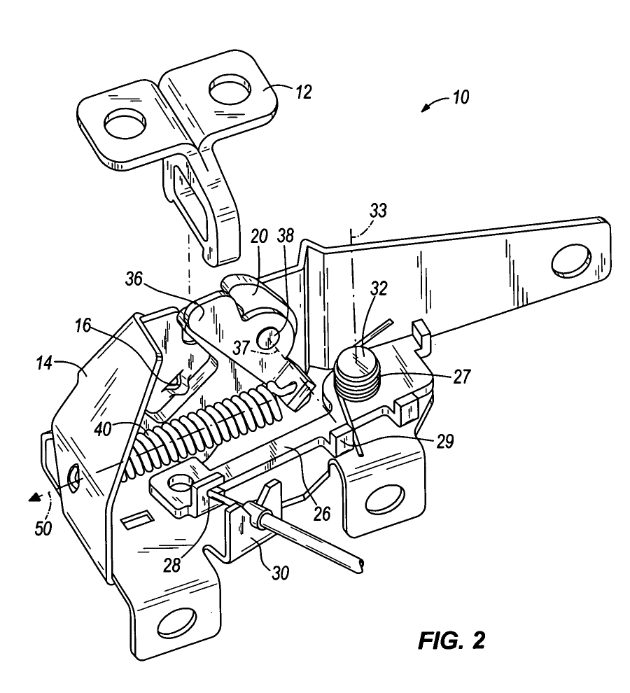

An embodiment of a latch assembly according to the present invention is illustrated in FIGS. 1-6. With reference first to FIG. 1, a latch assembly 10 is illustrated in a latched state in which a striker 12 is retained by the latch assembly 10. As shown in FIG. 2, the latch assembly 10 also has an unlatched state in which the striker 12 is released from the latch assembly 10.

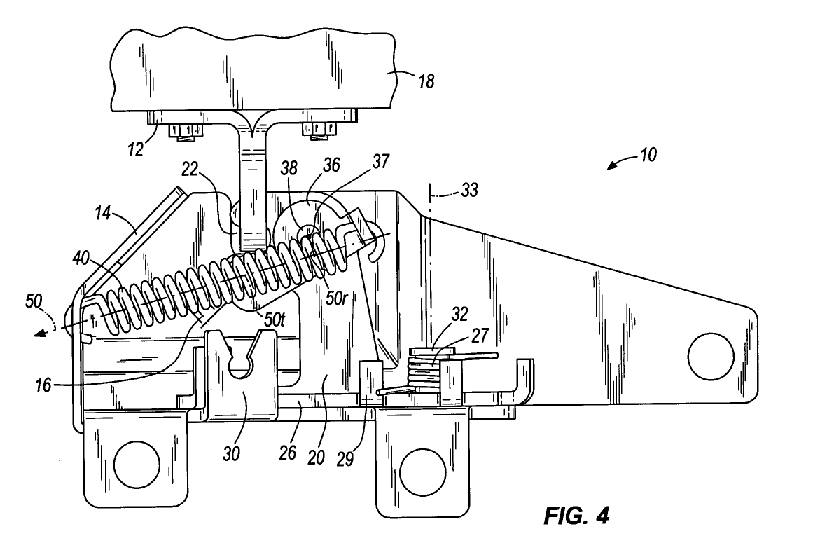

The latch assembly 10 releasably engages the striker 12 to control the release of a movable closure panel 18 of a vehicle (see FIGS. 4-6). The movable closure panel 18 can be any openable panel of a vehicle, including without limitation a hood, door, trunk, liftgate, tonneau cover, window, and the like. The term “closure panel” does not indicate or imply that such elements must be planar or substantially planar in shape. Such elements can have any shape suitable for covering and uncovering an opening of a vehicle, such as a doorway, an engine compartment, a trunk, truck bed, or other storage area, and the like.

In some embodiments, the striker 12 is coupled to a closure panel 18 and the latch assembly 10 is coupled to the vehicle adjacent the closure panel 18 (e.g., to a frame, a body panel, or other vehicle portion). Therefore, when the striker 12 is released from the latch assembly 10, the striker 12 and closure panel 18 can be moved away from the latch assembly 10 and adjacent vehicle portion, thereby moving the closure panel 18 to an opened position. In other embodiments, the latch assembly 10 can instead be coupled to the closure panel 18, and the striker 12 can instead be coupled to another portion of the vehicle. Therefore, the following description refers to the striker 12 coupled to the closure panel 18 and the latch assembly 10 coupled to an adjacent vehicle portion by way of example only.

The latch assembly 10 and striker 12 can be mounted directly to the vehicle portion and closure panel 18, respectively. Alternatively, the latch assembly 10 and/or striker 12 both can be directly or indirectly coupled to their respective vehicle portions (e.g., upon a mounting block, fixture, bracket, or other element or assembly coupled to the vehicle portion and closure panel 18), if desired. As used herein and in the appended claims, the term “coupled” does not necessarily mean that one element is directly fastened to another element. Instead, the term “coupled” means that one element is directly or indirectly connected to another element or is in mechanical communication with another element. Examples of elements “coupled” together include elements directly connected to one another (e.g., via welding, bolting, gluing, frictionally engaging, mating, etc.), elements connected to one another by one or more other elements, elements acting upon one another (e.g., via camming, pushing, or other interaction), and an element imparting motion directly or through one or more other elements to another element.

As illustrated in FIGS. 1-6, some embodiments of the latch assembly 10 according to the present invention can include a frame 14. The frame 14 can provide one or more mounting locations for coupling the latch assembly 10 to the vehicle or closure panel 18, and can provide one or more mounting locations for various other components of the latch assembly 10. The frame 14 can have any shape desired, such as a substantially planar shape, a body having portions extending in different directions and/or at different angles, and the like. Also, the frame 14 can include one or more elements, such as bars, panels, rods, and the like. Elements of the frame 14 can be coupled in any manner, such as by welding, brazing, fasteners, adhesive or cohesive bonding material, inter-engaging elements, and the like. In some embodiments, part or all of the frame 14 is manufactured by stamping, bending, casting, molding, machining, or other forming operations. Accordingly, the term “frame” encompasses structures defined by one or more elements manufactured in any manner.

In some embodiments of the present invention, a ratchet 20 is coupled to the frame 14 and is movable between a latched position in which the ratchet 20 captures and retains the striker 12 and an unlatched position in which the striker 12 is free to be removed from the ratchet 20. For example, the ratchet 20 in the illustrated embodiment of FIGS. 1-6 is coupled to a pivot 38 that is coupled to the frame 14, and is rotatable about an axis 37 at the pivot 38. In some embodiments, the pivot 38 can be integral with or otherwise non-rotatable with respect to the ratchet 20 or the frame 14. In other embodiments, the pivot 38 is rotatable with respect to the ratchet 20 and the frame 14. In the illustrated embodiment of FIGS. 1-6, the pivot 38 is a separate element fixed with respect to the frame 14 and about which the ratchet 20 can pivot.

In some embodiments, the rotational range of the ratchet 20 is limited in one or more manners and by one or more elements. For example, the range of rotation of the ratchet 20 toward a latched position can be limited by one or more stops, such as one or more walls, bosses, lips, ribs, bumps, pins, or other elements of the latch assembly 10. Such stops can be in any location in the latch assembly 10 in which the stops can perform this function, including without limitation on the frame 14 or pawl 26 of the latch assembly 10, on the lift lever 36 of the latch assembly 10 (described below), and the like. In the illustrated embodiment of FIGS. 1-6, the frame 14 has a projection 16 positioned to limit rotation of the ratchet 20 past the unlatched position shown in FIGS. 2, 5, and 6. In other embodiments, one or more other stops can limit rotation of the ratchet 20 past a latched position, if desired.

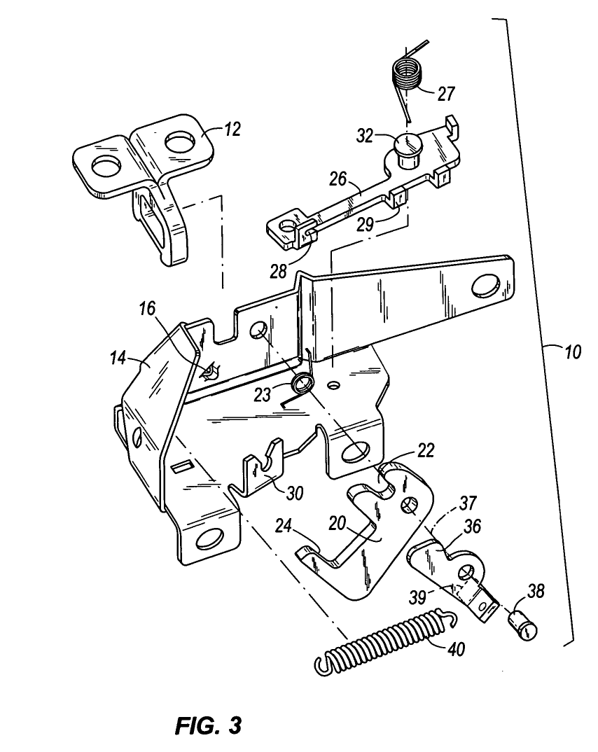

The ratchet 20 can have an opening 22 (see FIGS. 3-6) positioned to receive the striker 12 when the ratchet 20 is in the unlatched position and retaining the striker 12 when the ratchet 20 is in the latched position. In some embodiments, the ratchet 20 is biased toward the unlatched position to allow the striker 12 to enter and exit the opening 22. The ratchet 20 can be biased by one or more springs of any type, such as one or more extension, compression, leaf, or torsion springs, magnet sets, elastic members, and the like. In some embodiments, such springs can be directly coupled to the ratchet 20. Such springs can also or instead be coupled to the pivot 38 for rotatably biasing the pivot 38 (e.g., in those embodiments in which the pivot 38 is integral with the ratchet 20 or is otherwise fixed against rotation with respect to the ratchet 20). The springs can also be coupled to the frame 14 or other structure adjacent the latch assembly 10 when installed on the vehicle. In the illustrated embodiment of FIGS. 1-6, a torsion spring 23 (see FIG. 3) is mounted upon the pivot 38, and has one end coupled to the frame 14 and another end coupled to the ratchet 20 for biasing the ratchet 20 toward its unlatched position.

Some embodiments of the present invention include a pawl 26 coupled to the frame 14 and movable with respect to the ratchet 20 in order to releasably retain the ratchet 20 in one or more latched positions. For example, the pawl 26 in the illustrated embodiment of FIGS. 1-6 is coupled to a pivot 32 that is coupled to the frame 14, and is rotatable about an axis 33 at the pivot 32. In some embodiments, the pivot 32 can be integral with or otherwise non-rotatable with respect to the pawl 26 or the frame 14. In other embodiments, the pivot 32 is rotatable with respect to the ratchet 20 and the frame 14. In the illustrated embodiment of FIGS. 1-6, the pivot 38 is a separate element fixed with respect to the frame 14 and about which the ratchet 20 can pivot.

The pawl 26 can be biased into engagement with the ratchet 20 in order to limit rotation of the ratchet 20 in at least one rotational position of the ratchet 20. The pawl 26 can be biased by one or more springs of any type, including those mentioned above with reference to the ratchet spring. Also, the spring for the pawl 26 can be coupled to bias the pawl 26 in any of the manners described above with reference to the ratchet spring. By way of example only, the pawl 26 in the illustrated embodiment of FIGS. 1-6 is biased toward engagement with the ratchet 20 by a spring 27 on the pivot 32. The spring 27 is a torsion spring, and has one end coupled to the frame 14 and another end coupled to the pawl 26. The spring 27 is stopped by a tab 29 on the pawl 26 in the embodiment of FIGS. 1-6, although the spring 27 can be coupled to the pawl 26 in any other manner in order to exert spring force upon the pawl 26).

As mentioned above, the pawl 26 is movable with respect to the ratchet 20 to releasably retain the ratchet 20 in one or more latched positions, such as one or more rotational positions of the ratchet 20 illustrated in FIGS. 1-6. The ratchet 20 can have one or more abutment surfaces 24 (see FIG. 3) that abut the pawl 26 in such positions. The abutment surface(s) 24 can be any surface of the ratchet 20, such as a surface of a step, recess, notch, protrusion, or other portion of the periphery of the ratchet 20. When the pawl 26 is moved into engagement with the ratchet 20, engagement of the pawl 26 with one or more abutment surfaces 24 of the ratchet 20 can prevent the ratchet 20 from rotating to its unlatched position. However, when the pawl 26 is moved out of engagement with the ratchet 20 (in some cases, against the biasing force of the pawl spring 27), the ratchet 20 is free to rotate to its unlatched position. As described above, in some embodiments the ratchet 20 rotates under the biasing force of a ratchet spring 23.

In some embodiments, the pawl 26 is coupled to a release mechanism (not shown). The release mechanism can be located anywhere relative to the latch assembly 10, such as at a location adjacent the latch assembly 10 or in a location remote from the latch assembly 10. The release mechanism can be a handle, key cylinder, electrical actuator, lever, button, or any other manual or powered user control. When actuated, the remote release mechanism can move the pawl 26 out of engagement with the ratchet 20. By way of example only, in some embodiments the release mechanism includes a cable (not shown) coupled to the pawl 26 in any manner, such as through an aperture 28 in the pawl 26 as shown in the illustrated embodiment of FIGS. 1-6. In some embodiments, the cable can also be coupled to the frame 14 at one or more locations in order to further secure the cable (e.g., to secure the sheathing of a Bowden cable) and/or to route the cable. For example, the frame 14 in the illustrated embodiment of FIGS. 1-6 has a mount 30 to which the cable can be connected. The mount 30 can take any form and shape desired, and in some embodiments is an apertured portion of the frame 14 through which the cable passes. When the cable is actuated by a release mechanism coupled to the cable, the cable moves the pawl 26 out of engagement with the ratchet 20, thereby permitting the ratchet 20 to rotate to its unlatched position. In other embodiments, the pawl 26 can be coupled to a cable in any other manner, such as by conventional fasteners, crimping, and the like. Also, in some embodiments the pawl 26 can be coupled to a remote release mechanism by one or more other elements (other than or in addition to a cable), such as one or more rods, levers, and the like.

Some embodiments of the latch assembly 10 also include a lift lever 36 movable to push the striker 12 in a direction away from the latch assembly 10 when the latch assembly 10 moves toward and/or is in an unlatched state. The lift lever 36 can be coupled to the frame 14, the ratchet 20, or another component of the latch assembly 10 while still performing this function. For example, in the embodiment illustrated in FIGS. 1-6, the lift lever 36 is coupled to or is integral with the pivot 38 (described above), and is rotatable about the same axis 37 as the ratchet 20. An advantage in such embodiments is the use of fewer parts and/or a more compact design of the latch assembly 10. In other embodiments, the lift lever 36 is coupled to or is integral with another pivot (not shown), and is rotatable about an axis at the pivot. This lift lever pivot can extend from the ratchet 20, from the frame 14, or from another component of the latch assembly 10. In such embodiments, the axis of rotation of the lift lever 36 can be parallel to the axis of rotation 37 of the ratchet 20, and in some embodiments can be axially aligned with the axis of rotation 37 of the ratchet 20. However, in other embodiments, these axes need not necessarily be aligned or parallel.

With continued reference to the illustrated embodiment of FIGS. 1-6, in some embodiments the lift lever 36 can be pivotable with respect to the ratchet 20. In such embodiments, the rotational range of the lift lever 36 can be limited in one or more manners and by one or more elements, including any of those described above with reference to limiting rotation of the ratchet 20. In the illustrated embodiment of FIGS. 1-6, the lift lever 36 is limited by a projection 39 (see FIG. 1) of the lift lever 36 stopped by a surface of the ratchet 20. Therefore, the lift lever 36 in the illustrated embodiment of FIGS. 1-6 can pivot with respect to the ratchet 20, but has a rotational range limited by the ratchet 20.

In some embodiments, the lift lever 36 is pivotable through a range of positions as the latch assembly 10 moves between latched and unlatched states. In the unlatched state, the lift lever 36 is biased toward an unlatched position by a spring (e.g., an extension spring 40 in the illustrated embodiment of FIGS. 1-6), and exerts force upon the striker 12 in a direction away from the latch assembly 10. The lift lever 36 need not necessarily contact or engage the striker 12 for this purpose. For example, in some cases an element is located between the lift lever 36 and the striker 12, and transmits force from the lift lever 36 to the striker 12. In other embodiments (such as the illustrated embodiment of FIGS. 1-6), the lift lever 36 engages and biases the striker 12 in a direction away from the latch assembly 10.

The biasing force upon the striker 12 by the lift lever 36 can be exerted through a range of positions of the ratchet 20, such as from a latched position of the ratchet 20 (see FIGS. 1 and 4) through an unlatched position of the ratchet 20 (see FIGS. 2, 5, and 6), or in any portion of this range. In the illustrated embodiment of FIGS. 1-6, the lift lever 36 exerts a biasing force upon the striker 12 to a position in which the striker 12 is substantially out of the opening 22 of the ratchet 20 in the unlatched position of the ratchet 20.

As described above, the lift lever 36 is biased toward an unlatched position by a spring. This lift lever spring can take any form, including any of those described above with reference to the springs of the ratchet 20 and pawl 26. In the illustrated embodiment for example, the lift lever spring is an extension spring 40 coupled to the lift lever 36 and to the frame 14. In other embodiments, the spring can be a compression spring coupled to and between the lift lever 36 and the frame 14. Still other types of springs can be used, and fall within the spirit and scope of the present invention.

The spring 40 in the illustrated embodiment of FIGS. 1-6 is coupled to the lift lever 36 at a location a distance from the axis of rotation 37 of the lift lever 36. Therefore, the spring 40 exerts a force along a vector 50 that does not pass through the axis of rotation 37 of the lift lever 36 (see FIGS. 4-6). The position and orientation of the force vector 50 is determined at least in part by the connection locations of the spring 40 on the frame 14 and lift lever 36. The resulting torque upon the lift lever 36 biases the lift lever 36 in a rotational direction in which the lift lever 36 exerts force upon the striker 12 as described above.

When sufficient force is applied to the lift lever 36 by the striker 12 (e.g., as the closure panel 18 is moved toward a closed position), the lift lever 36 in the illustrated embodiment of FIGS. 1-6 pivots about the axis of rotation 37 of the lift lever 36 against the bias force of the ratchet spring 23 and the spring 40 coupled to the lift lever 36. As such, the striker 12 is able to enter the opening 22 in the ratchet 20 and move the ratchet 20 to its latched position. The lift lever 36 can remain biased against the striker 12 in the latched state of the latch assembly 10 due to stored energy in the spring 40 coupled to the lift lever 36. In some embodiments, however, a pawl or other element or mechanism can be used to selectively prevent the lift lever 36 from exerting a biasing force against the striker 12 when the latch assembly 10 is in a latched state. Upon release of the pawl 26 from the ratchet 20, the lift lever 36 can move the striker 12 in a direction away from the latch assembly 10 and to a position in which the striker 12 can be or is removed from the opening 22 in the ratchet 20.

In some embodiments of the present invention, the lift lever 36 is biased to exert a first amount of force upon the striker 12 when the lift lever 36 is in a latched position, and a greater amount of force upon the striker 12 when the lift lever 36 is in an unlatched position. As described in greater detail below, such an arrangement can result in lower forces required to close the closure panel 18 and/or lower forces required to unlatch the latch assembly 10. The lift lever 36 can be biased as just described by using a spring (e.g., an extension spring 40 in the illustrated embodiment of FIGS. 1-6) exerting different amounts of force in different rotational positions of the lift lever 36. This varying force can be generated by changing the state of the spring and/or by changing the position of the spring with respect to the axis of rotation 37 of the lift lever 36. With reference to the illustrated embodiment of FIGS. 1-6, for example, different rotational forces are exerted upon the lift lever 36 by flexing the spring 40 to different lengths and by changing the position of the spring 40 with respect to the axis of rotation 37 of the lift lever 36. By changing the length of the spring 40, the magnitude of force exerted by the spring 40 changes. Also, by changing the position of the spring 40 with respect to the axis of rotation 37 of the lift lever 36, the moment arm of the lift lever 36 changes, thereby changing the rotational force upon the lift lever 36. Either or both manners of changing the rotational force upon the lift lever 36 can be used in different embodiments of the present invention.

With continued reference to the embodiment of FIGS. 1-6, the length and position of the spring 40 changes as the lift lever 36 rotates, thereby resulting in different forces exerted upon the striker 20 at different rotational positions of the lift lever 36 (i.e., a striker force profile). By changing the spring 40 with another spring having different characteristics and/or by changing the position of the spring 40 with respect to the axis of rotation 37 of the lift lever 36, different striker force profiles can be generated for the latch assembly 10. Such striker force profiles can include forces of the lift lever 36 upon the striker 20 that increase, decrease, or remain substantially constant as the lift lever 36 is pivoted toward an unlatched position, forces of the lift lever 36 upon the striker 20 that increase and then decrease, decrease and then increase, increase or decrease and then remain substantially constant for an amount of lift lever rotation (or vice versa), and the like.

With reference again to the illustrated embodiment of FIGS. 1-6, the position of the spring 40 in the latch assembly 10 is selected to produce a moment on the lift lever 36 in the latched position of the lift lever 36 and a greater moment on the lift lever 36 in the unlatched position of the lift lever 36. In this manner, a relatively low force is exerted by the lift lever 36 upon the striker 12 when the striker 12 is in a latched position, and a higher force is exerted by the lift lever 36 upon the striker 12 when the striker 12 is in an unlatched position.

FIGS. 1 and 4 show the latch assembly 10 in a latched state. In this state, the spring 40 is in an extended state producing a rotational force upon the lift lever 36. Although the spring 40 exerts a relatively large amount of force upon the lift lever 36 in this state (compared to the less extended state of the spring 40 illustrated in FIGS. 2, 5, and 6), the spring 40 also produces a relatively low amount of torque upon the lift lever 36 in this state. When the latch assembly 10 is in a latched state as shown in FIGS. 1 and 4, the force vector 50 of the spring 40 is relatively close to the axis of rotation 37 of the lift lever 36. Therefore, although the spring 40 is stressed and produces a relatively large force upon the lift lever 36, the torque on the lift lever 36 and the force exerted by the lift lever 36 upon the striker 12 is relatively low.

With reference to FIG. 4, when the force exerted by the spring 40 upon the lift lever 36 is broken into a radial component 50r and a tangential component 50t, the tangential component 50t is relatively small compared to the radial component 50r. Since the radial component 50r of the force passes through the axis of rotation 37 of the lift lever 36, the radial component 50r of the force produces no torque on the lift lever 36. However, the tangential component 50t of the force produces a torque equal to the tangential component 50t multiplied by the distance the tangential component 50t is applied from the axis of rotation 37 of the lift lever 36 (i.e., the moment arm of the lift lever 36). Since the tangential component 50t is relatively small, the torque on the lift lever 36 is also relatively small.

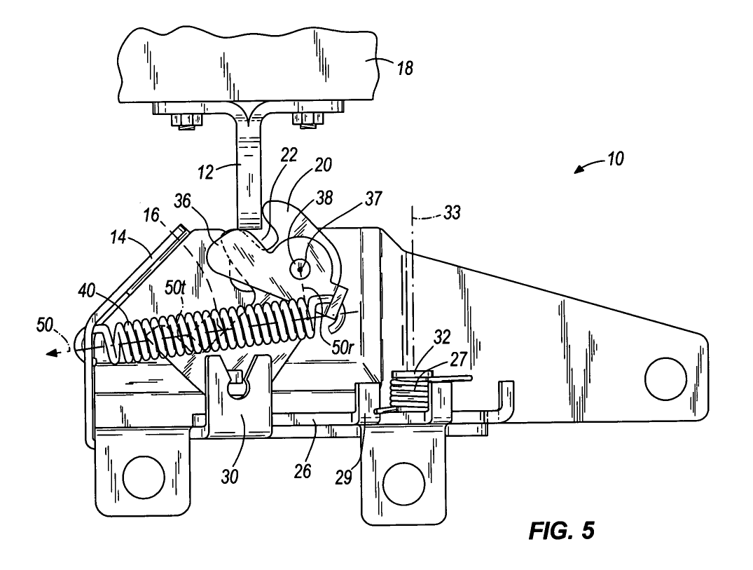

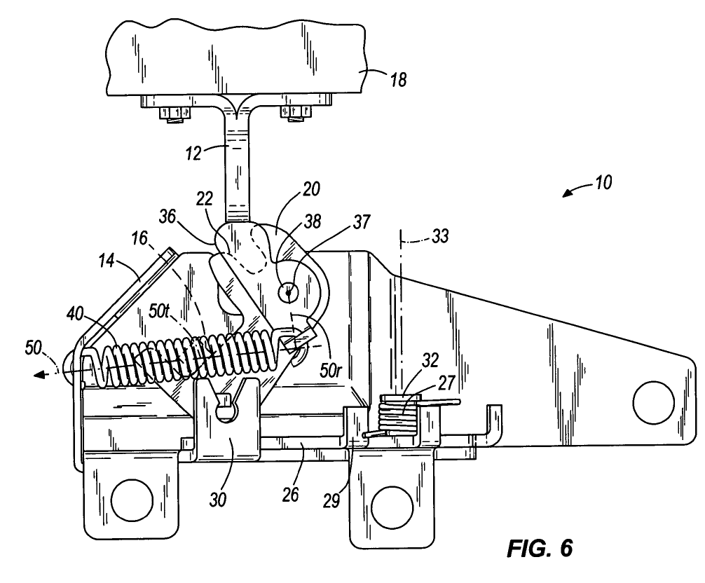

FIGS. 2, 5, and 6 show the latch assembly 10 in an unlatched state. In this state, the spring 40 is less extended than the spring state illustrated in FIGS. 1 and 4. Therefore, the spring 40 exerts a lower amount of force upon the lift lever 36 compared to the latched state of the spring 40 illustrated in FIGS. 1 and 4. However, the spring 40 also produces a larger amount of torque upon the lift lever 36 in the state illustrated in FIGS. 2, 5, and 6. As best shown in FIGS. 5 and 6, the force vector 50 of the spring 40 is farther away from the axis of rotation 37 of the lift lever 36 than when the latch assembly 10 is in the latched state. Therefore, although the spring 40 is less stressed and produces a lower amount of force upon the lift lever 36, the torque on the lift lever 36 and the force exerted by the lift lever 36 upon the striker 12 is higher than when the latch assembly 10 is in the latched state.

With reference to FIGS. 5 and 6, when the force exerted by the spring 40 upon the lift lever 36 is broken into a radial component 50r and a tangential component 50t, the tangential component 50t is larger than when the latch assembly 10 is in the latched state. Since the radial component 50r of the force passes through the axis of rotation 37 of the lift lever 36, the radial component 50r produces no torque on the lift lever 36. However, the tangential component 50t of the force produces a torque equal to the tangential component 50t multiplied by the distance the tangential force 50t is applied from the axis of rotation 37 of the lift lever 36 (i.e., the moment arm of the lift lever 36). Since the tangential component 50t is larger than when the latch assembly 10 is in the latched state, the torque on the lift lever 36 is greater.

In the illustrated embodiment of FIGS. 1-6, the torque upon the lift lever 36 increases as the lift lever 36 is pivoted to its unlatched position as described above. This relationship is achieved in part by coupling the spring 40 such that the force vector 50 of the spring 40 moves away from the axis of rotation 37 of the lift lever 36 as the lift lever 36 moves to its unlatched position, thereby increasing the moment arm of the lift lever 36 as the lift lever 36 moves to its unlatched position. The force vector 50 need not necessarily pass through or in close proximity to the axis of rotation 37 of the lift lever 36 in the latched position of the lift lever 36. Instead, similar latch characteristics can be produced for any spring force vector 50 located a larger distance from the axis of rotation 37 in an unlatched position than in a latched position.

As mentioned above, the position of the spring 40 relative to the lift lever 36 and the characteristics of the spring 40 at least partially define the profile of torques upon the lift lever 36 at different rotational positions of the lift lever 36. This torque profile can be changed by changing the position of the spring 40 relative to the lift lever 36 (e.g., changing the location and/or orientation of the spring 40 in the latched and unlatched states of the lift lever 36, changing the locations at which the spring 40 is coupled to the lift lever 36 and/or to the frame 14, and the like), arid/or by changing the type of spring 40 used (e.g., using a spring 40 having a different spring constant or spring force curve). For example, the spring 40 in the embodiment of FIGS. 1-6 can be replaced with another spring having a different force curve, such as a spring 40 exerting greater force when extended and/or less force when relaxed, relative to corresponding forces exerted by the spring 40 in the illustrated embodiment of FIGS. 1-6. In such embodiments, the lift lever 36 can have increased torque when the lift lever 36 is in the latched position and/or reduced torque when the lift lever 36 is in the unlatched position (compared to the embodiment of FIGS. 1-6 described above). Alternatively, the spring 40 in the embodiment of FIGS. 1-6 can be replaced with another spring exerting reduced force when extended and/or greater force when relaxed, relative to corresponding forces exerted by the spring 40 in the illustrated embodiment of FIGS. 1-6. In such embodiments, the lift lever 36 can have increased torque when the lift lever 36 is in the unlatched position and/or reduced torque when the lift lever 36 is in the latched position (compared to the embodiment of FIGS. 1-6 described above).

As another example, the spring 40 and the lift lever 36 can be positioned relative to one another so that the force vector 50 of the spring 40 is located a greater distance from the axis of rotation 37 of the lift lever 36 when the lift lever 36 is in a latched position than when the lift lever 36 is in an unlatched position. In such an embodiment, when the lift lever 36 is rotated to an unlatched position as described herein, the force vector 50 of the spring 40 moves nearer to the axis of rotation 37 of the lift lever 36 as the spring 40 relaxes. Accordingly, the spring 40 and lift lever 36 can exert more biasing force against the striker 20 in the latched state than in the unlatched state.

As yet another example, the spring 40 can be selected to have a force curve in which the mechanical advantage provided by an increasing or decreasing moment arm (from pivoting the lift lever 36 as described above) is substantially offset by increasing or decreasing forces exerted by the spring 40 as the spring 40 is flexed. In such a manner, the resulting force exerted by the lift lever 36 upon the striker 12 can be constant or substantially constant throughout any portion or all of the range of movement of the lift lever 36.

The position of the spring 40 relative to the lift lever 36 and the characteristics of the spring 40 can be selected in any combination resulting in an increase or decrease in torque upon the lift lever 36 as the lift lever 36 is pivoted between latched and unlatched positions. By way of example only, a spring 40 generating reduced spring forces can be positioned at greater distances from the axis of rotation 37 of the lift lever 36 to result in an increase or decrease in torque upon the lift lever 36 as the lift lever 36 is pivoted to an unlatched position. As another example, a spring 40 generating greater spring forces can be positioned at smaller distances from the axis of rotation 37 of the lift lever 36 to result in an increase or decrease in torque upon the lift lever 36 as the lift lever 36 is pivoted to an unlatched position. The resulting increase or decrease in torque upon the lift lever 36 can be dependent at least in part upon the size of the spring forces and the distances between the force vector 50 of the spring 40 and the axis of rotation 37 of the lift lever 36 as the lift lever 36 is pivoted.

The spring characteristics (e.g., the spring force curve of the spring 40, the length of the spring 40, and the like) and relative positions of the lift lever 36 and spring 40 can be selected so that any torque profile can be generated upon the lift lever 36 through the range of motion of the lift lever 36. The torque upon the lift lever 36 can increase, decrease, stay substantially constant, or have combinations of such characteristics in any sequence as the lift lever 36 is pivoted. In the illustrated embodiment of FIGS. 1-6, however, the torque upon the lift lever 36 decreases as the lift lever 36 is pivoted to its latched position, thereby providing the latch characteristics described above. Accordingly, in the illustrated embodiment of FIGS. 1-6, the forces exerted upon the striker 12 by the latch assembly 10 when the striker 12 is in a latched position are relatively low compared to forces exerted upon the striker 12 by the latch assembly 10 when the striker 12 is in other positions (e.g., in movement of the striker 12 toward an unlatched position). Latches having such a feature can be used in applications where forces urging the striker 12 to an unlatched position should be reduced or minimized when the latch assembly 10 is in a latched state.

With continued reference to the illustrated embodiment of FIGS. 1-6, when the latch assembly 10 is released from the latched state, both the lift lever 36 and the ratchet 12 can be biased into respective open and unlatched positions as shown in FIGS. 2, 5, and 6. In the unlatched or released state of the latch assembly 10, the striker 12 can rest upon the lift lever 36. Depending at least in part upon the shape of the ratchet 12, the shape of the lift lever 36, the ranges of rotation of the ratchet 12 and lift lever 36, the torque upon the lift lever 36 generated by the spring 40, and the amount of force upon the striker 12 in a direction toward the latch assembly 10, the lift lever 36 can move the striker 12 out of the opening 22 in the ratchet 12, or can instead move the striker 12 to a position still within the ratchet opening 22. As shown in FIGS. 2, 5, and 6, the torque on the lift lever 36 in the unlatched position is sufficient to move the striker 12 out of the opening 22 in the ratchet 20. In some embodiments, the striker 12 is moved sufficiently to create a clearance between the closure panel 18 and an adjacent portion of the vehicle (not shown) for a person to insert a finger or hand, such as to grasp and/or move the closure panel 18, to actuate one or more elements behind the closure panel 18, and the like.

Forces exerted upon the striker 12 when the illustrated latch assembly 10 is in a latched state can be transmitted to one or more surfaces of the ratchet 20 (e.g., upon one or more edges of the ratchet opening 22 in some embodiments), and therefore to the ratchet 20. In conventional latch assemblies, forces upon a ratchet in its latched state are often responsible for generating higher frictional engagement with a pawl and/or other elements of the latch assembly, thereby increasing the force needed to release the pawl from the ratchet and/or other elements of the latch assembly. By reducing the amount of force exerted upon the striker 12, some embodiments of the present invention reduce the amount of force exerted upon the ratchet 20 and pawl 26. In this manner, the amount of force needed to release the pawl 26 from the ratchet 20 can be reduced. In some embodiments, this force can be reduced even though the spring 40 exerts a relatively high force when in the latched state of the latch assembly 10 as described above.

As also described above, in some embodiments the lift lever 36 exerts a decreasing force upon the striker 12 as the striker 12 is moved to a latched position. For example, as the striker 12 in the illustrated embodiment of FIGS. 1-6 moves from the unlatched position shown in FIGS. 2, 5, and 6 to the latched position shown in FIGS. 1 and 4, the lift lever 36 exerts a decreasing force upon the striker 12 in a direction away from the latch assembly 10. Accordingly, the closure panel 18 can become increasingly easier for a user to close as the closure panel 18 is moved to a closed and latched position.

In operation of the illustrated embodiment of FIGS. 1-6, when a closing force is applied to a closure panel 18 in the position of FIG. 6, a force is applied to the striker 12 to move the lift lever 36 in a counter-clockwise direction (as viewed in the figures). This force is exerted against the torque on the lift lever 36 exerted by the spring 40. However, as the lift lever 36 in FIG. 6 moves toward the latched position shown in FIGS. 1 and 4, the torque caused by the spring 40 decreases. As the lift lever 36 moves, the striker 12 enters the opening 22 in the ratchet 20, and engages a portion of the ratchet 20 to rotate the ratchet 20 in a counter-clockwise direction. In some embodiments, the striker 12 moves with respect to the axis of rotation of the ratchet 20 as the striker 12 moves the lift lever 36 to its latched position. Upon rotation of the ratchet 20 toward the latched state shown in FIGS. 1 and 4, a portion of the ratchet 20 at least partially surrounds a portion of the striker 12 and blocks the path of the striker 12 out of the latch assembly 10. Furthermore, as the ratchet 20 rotates toward the latched position, the pawl 26 engages the abutments 28 on the ratchet 20 to prevent rotation of the ratchet 20 toward an unlatched position. In the latched position shown in FIGS. 1 and 4, the ratchet 20 is prevented from rotating toward an unlatched position, and the striker 12 is prevented from escaping the latch assembly 10. The striker 12 can also be biased against the ratchet 20 by energy stored in the spring 40 coupled to the lift lever 36.

To unlatch the latch assembly 10 illustrated in FIGS. 1-6, the pawl 26 is disengaged from the ratchet 20 by pulling upon a cable (not shown) coupled to the pawl 26 at the aperture 28 in the pawl 26. Energy stored in the latch assembly 10 during the latching process is thereby released. This allows the ratchet 20 and the lift lever 36 to rotate toward their unlatched positions due to the torques on the ratchet 20 and lift lever 36. As the lift lever 36 moves toward the unlatched position shown in FIGS. 2, 5, and 6, the torque on the lift lever 36 increases, exerting an increasing force upon the striker 12 as the striker 12 is moved toward an unlatched position. Also, in some embodiments, the lift lever 36 moves the striker 12 away from the axis of rotation 37 of the ratchet 20 during at least part of the motion of the lift lever 36. For example, the lift lever 36 in the embodiment of FIGS. 1-6 moves the striker 12 away from the axis of rotation 37 of the ratchet 20 in a range of movement of the lift lever 36, including when the ratchet 20 has stopped pivoting and the lift lever 36 continues to move the striker 12 out of the ratchet opening 22. When the ratchet 20 reaches the unlatched position shown in FIGS. 2 and 5 (stopped by the projection 16 from the frame 14), the lift lever 36 continues to rotate to lift the striker 12 from the opening 22 in the ratchet 12 and to provide greater clearance between the closure panel 18 and an adjacent portion of the vehicle. Upon reaching the position shown in FIG. 6, further rotation of the lift lever 36 is stopped by the projection 39 of the lift lever 36 upon the ratchet 20.

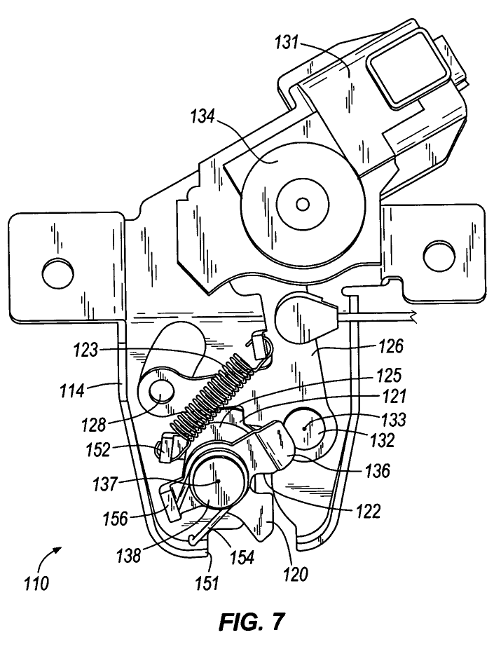

FIGS. 7-11 illustrate another embodiment of a latch assembly according to the present invention. This embodiment uses similar elements and has many of the same operational features as the embodiments described above with reference to FIGS. 1-6. Accordingly, the following description focuses primarily upon those elements and features that are different from the embodiments described above. Reference should be made to the above description for additional information regarding the elements, features, and possible alternatives to the elements and features of the latch assembly 110 illustrated in FIGS. 7-11 and described below. Elements and features of the embodiment shown in FIGS. 7-11 that correspond to elements and features of the embodiments described with reference to FIGS. 1-6 above are designated hereinafter in the 100 series of reference numbers.

Like the embodiment of the present invention illustrated in FIGS. 1-6, the embodiment illustrated in FIGS. 7-11 has a frame 114, a pawl 126 releasably engagable with a ratchet 120, and a lift lever 136. The ratchet 120 and lift lever 136 are both coupled to the frame 114 by a pivot 138, and are rotatable about an axis 137 at the pivot 138. The pawl 126 is also coupled to the frame 114 by a pivot 132 for movement with respect to the ratchet 120. The pawl 126 in the embodiment of FIGS. 7-11 is rotatable about an axis 133 that is substantially parallel to the axis of rotation 137 of the ratchet 120 and lift lever 136. In other embodiments, the pawl 126 can be rotatable about an axis having any other orientation with respect to the axis of rotation 137 of the ratchet 120 and/or lift lever 136 while still being movable into and out of engagement with the ratchet 120 to selectively prevent movement of the ratchet 120 to an unlatched position. As described above, the pawl 126 can also be movable in other manners for this purpose.

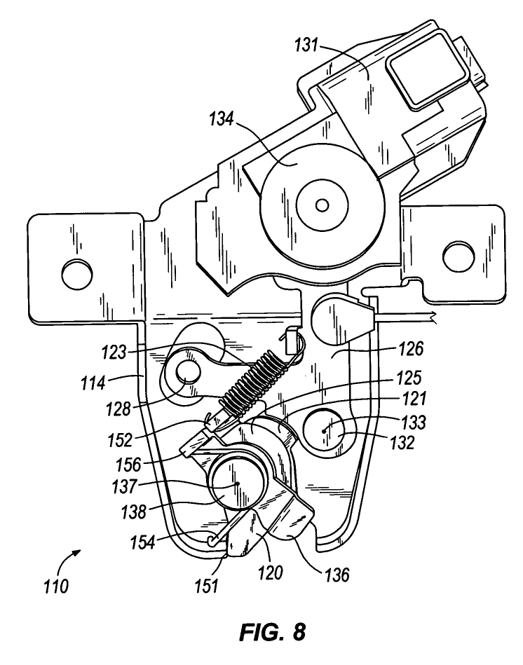

The pawl 126 can be actuated in any of the manners described above with reference to the embodiment of FIGS. 1-6, and can be actuated by any number of different release mechanisms. In the embodiment of FIGS. 7-11, the pawl 126 can be coupled to a lock cylinder, a handle, or other user-manipulatable device coupled to the pawl 126 at an aperture 128 in the pawl 126. This connection can instead be made at another feature of the pawl 126, such as at a boss, flange, lip, mount or other feature of the pawl 126. The pawl 126 illustrated in FIGS. 7-11 is also coupled to an electric motor 131 by a gear assembly 134 (see FIGS. 7 and 8), and can be moved by actuation of the electric motor 131 and gear assembly 134. Accordingly, the latch assembly 110 illustrated in FIGS. 7-11 can be released by manual or powered devices. In other embodiments, two or more manual devices and/or two or more powered devices can be coupled to the latch assembly 110 for this purpose.

In some embodiments of the present invention, a wear portion of the ratchet 120 comprises a material that is different than a remainder of the ratchet 120. The wear portion can have lower friction properties and/or can be more resistant to wear than the materials of the remainder of the ratchet 120, and can be coupled thereto in a number of different manners. In the illustrated embodiment of FIGS. 7-11, for example, a wear portion 121 of the ratchet 120 is overmolded upon the remainder 125 of the ratchet 120, which can comprise metal, plastic, composite material, or other sufficiently strong material. An overmolded wear portion 121 can provide a secure connection between the wear portion 121 and the remainder 125 of the ratchet 120, and in some embodiments can be manufactured at relatively low cost. In other embodiments, the wear portion 121 is coupled to the remainder 125 of the ratchet 120 in any other manner, such as by adhesive or cohesive bonding material, by inter-engaging elements, by pins, screws, rivets, and other fasteners, and the like.

The wear portion 121 of the ratchet 120 can comprise plastic, UHMW, urethane, nylon, and the like, although any other material can be used. The wear portion 121 is positioned to contact the pawl 126, and can provide reduced friction between the ratchet 120 and the pawl 126 and/or improved resistance to ratchet wear. In some embodiments, the pawl 126 only contacts the ratchet 120 at the wear portion 121. However, in other embodiments, the pawl 126 can contact the remainder 125 of the ratchet 120 in one or more locations or ranges of locations on the ratchet 120. Also, in some embodiments, one or more abutment surfaces 124 of the ratchet 120 can be located on the wear portion 121. For example, the ratchet 120 illustrated in FIGS. 7-11 has an abutment surface 124 on the wear portion 121 of the ratchet 120.

The ratchet 120 in the embodiment of FIGS. 7-11 is rotatable between latched and unlatched positions in order to capture a striker 112 as described in greater detail above. As best shown in FIGS. 7, 10, and 11, the ratchet 120 can rotate to an unlatched position in which the striker 112 is or can be removed from the ratchet 120. The ratchet 120 can be stopped in this position in any of the manners described above. In the embodiment of FIGS. 7-11, the ratchet 120 is stopped by a wall 151 of the frame 114.

The ratchet 120 illustrated in FIGS. 7-11 is also biased by a spring 123 coupled to the ratchet 120. The spring 123 can be coupled to the ratchet 120 at a flange or other projection 152 of the ratchet 120 as shown in FIGS. 7-11, or can instead be coupled to bias the ratchet 120 in any of the other manners described above. Also, the spring 123 can be coupled to a location of the pawl 126 as illustrated, or can be coupled to the frame 114 or other part of the latch assembly 110.

With continued reference to the embodiment illustrated in FIGS. 7-11, the lift lever 136 is rotatable between latched and unlatched positions, and is biased toward an unlatched position by a torsion spring 154 coupled to the lift lever 136. The torsion spring 154 can be coupled to the lift lever 136 in any manner, such as to a projection 156 as illustrated in FIGS. 7-11, to an aperture or other feature of the lift lever 136, and the like. The torsion spring 154 can also have a portion positioned to contact the frame 114 or other part of the latch assembly 110.

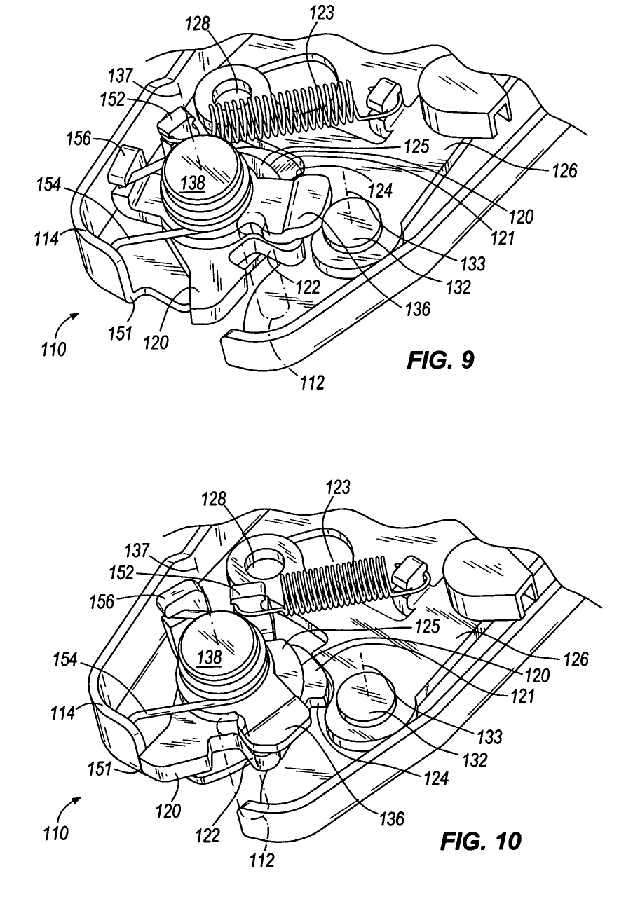

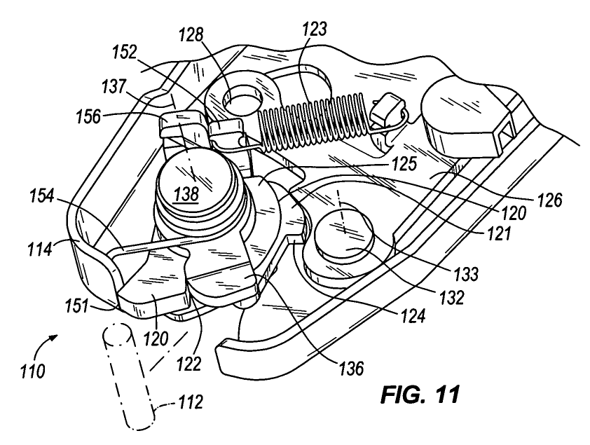

When the latch assembly 110 illustrated in FIGS. 7-11 is in a latched state, the striker 112 is received within an opening 122 of the ratchet 120, and the lift lever 136 is rotated to a latched position as shown in FIGS. 7 and 9. When the latch assembly 110 is released by actuating the pawl 126 as described above, the ratchet 120 and lift lever 136 each rotate toward their respective unlatched positions shown in FIGS. 8, 10, and 11 under biasing force from their respective springs 123, 154. However, the ratchet 120 illustrated in FIGS. 7-11 is stopped by the wall 151 of the frame 114, while the lift lever 110 can continue to rotate to the position shown in FIGS. 8 and 11. The lift lever 110 can therefore continue to move the striker 112 in a direction away from the latch assembly 110. In some embodiments, the lift lever 136 moves the striker 112 at least partially out of the opening 122 in the ratchet 120.

In some embodiments, the rotational range of the lift lever 136 can be limited in one or more manners and by one or more elements, including any of those described above with reference to limiting rotation of the ratchet 20 in the embodiment of FIGS. 1-6. In the illustrated embodiment of FIGS. 7-11, the lift lever 136 is limited by the projection 156 of the lift lever 136 stopped by a surface of the ratchet 120. Any surface of the ratchet 120 can be used for this purpose. In the embodiment of FIGS. 7-11, for example, the projection 156 of the lift lever 136 is stopped by the projection 152 of the ratchet 120. Therefore, the lift lever 136 in the illustrated embodiment of FIGS. 7-11 can pivot with respect to the ratchet 120, but has a rotational range limited by the ratchet 120. In other embodiments, rotation of the lift lever 136 can be limited by direct or indirect contact between any other portion of the lift lever 136 and any other portion of the ratchet 120.

The embodiments described above and illustrated in the figures are presented by way of example only, and are not intended as a limitation upon the concepts and principles of the present invention. As such, it will be appreciated by one having ordinary skill in the art that various changes in the elements and their configuration and arrangement are possible without departing from the spirit and scope of the present invention. For example, in the illustrated embodiments of FIGS. 1-11, a lift lever 36, 136 is used to move the striker 12, 112 from the ratchet 20, 120, and is separate from and movable with respect to the ratchet 20, 120. However, in other embodiments, the latch assembly 10, 110 can have a ratchet 20, 120 that is integral with the lift lever 36, 136 or that is coupled to the lift lever 36, 136 so that the lift lever 36, 136 is not rotatable with respect to the ratchet 20, 120. Thus, some embodiments of the present invention can use the other features of the present invention to bias the lift lever 36, 136 and/or ratchet 20, 120 in a manner similar to the manner in which the lift lever 36, 136 is biased in the illustrated embodiments of FIGS. 1-11.

As another example, various elements of the latch assembly 10, 110 are described as being pivotable or rotatable. It will be appreciated that in alternative embodiments, such elements can be coupled to permit other types of movement while still performing the functions of such elements as described herein. By way of example only, the pawl 26, 126 in the illustrated embodiments of FIGS. 1-11 is rotatable about a pawl pivot 32, 132 in order to releasably engage the ratchet 20, 120. In alternative embodiments, the pawl 26, 126 can move in other manners, such as by translating (e.g., wherein the pawl 26, 126 is slidably coupled to the frame 14, 114, such as by one or more grooves or other elongated apertures in the frame 14, 114) or by a combination of translation and rotation. In such cases, the pawl 26, 126 can be coupled to the frame 14, 114 in any suitable manner to enable such motion.

As yet another example, in some embodiments of the present invention, a lift lever spring 40, 154 can be coupled to the lift lever 36, 136 and/or to the frame 14, 114 in two or more locations, each providing different moments on the lift lever 36, 136 in the latched and/or unlatched positions of the lift lever 36, 136. The spring 40, 154 can therefore be installed in different manners to change the manner in which the latch assembly 10, 110 operates, such as to increase or decrease the required closing and latching force of the latch assembly 10, 110, to change the force needed to unlatch the latch assembly 10, 110, and the like.

1. A vehicle latch for releasably securing a striker with respect to the latch, the latch comprising:
a ratchet pivotable about an axis between a latched position in which the ratchet retains the striker and an unlatched position in which the striker can be removed from the ratchet;
a pawl engageable with the ratchet to selectively prevent pivoting of the ratchet from the latched position to the unlatched position; and
a lever engagable with the striker and pivotable about the axis to at least assist in moving the striker from a first position with respect to the axis to a second position with respect to the axis, wherein the second position is located a greater distance from the axis than the first position.

2. The vehicle latch as claimed in claim 1, wherein the lever and ratchet are pivotable about a common pivot coupled to a frame.

3. (canceled)

4. The vehicle latch as claimed in claim 1, wherein the ratchet is biased toward the unlatched position.

5. The vehicle latch as claimed in claim 1, wherein the lever is biased by a spring to move the striker.

6. The vehicle latch as claimed in claim 5, wherein the spring is positioned to produce a torque on the lever in at least some positions of the lever, the torque having a first magnitude when the latch is in an unlatched state and a second magnitude less than the first magnitude when the latch in a latched state.

7. The vehicle latch as claimed in claim 5, wherein:
the spring produces a force on the lever when the latch is in a latched state;
the force has a radial component and a tangential component with respect to the lever; and
the radial component of the force is greater than the tangential component of the force when the latch is in the latched state.

8. The vehicle latch as claimed in claim 7, wherein:
the spring produces a second force on the lever when the latch is in an unlatched state;
the second force has a radial component and a tangential component with respect to the lever; and
the radial component of the second force is less than the tangential component of the second force when the latch is in the unlatched state.

9. The vehicle latch as claimed in claim 5, wherein:
the spring produces first torque on the lever when the latch is in a latched state and a second torque on the lever when the latch is in an unlatched state; and
the first torque is smaller than the second torque.

10. A vehicle latch for releasably securing a striker with respect to the latch, the latch comprising:
a ratchet having a latched position in which separation of the striker from the ratchet is restricted and an unlatched position in which the striker can be separated from the ratchet;
a pawl releasably engagable with the ratchet to selectively prevent movement of the ratchet from the latched position; and
a lever pivotable with respect to the ratchet, the lever biased in a pivoting direction and positioned to exert an unlatching force on the striker, the unlatching force having a first magnitude when the ratchet is in the latched position and a second magnitude when the ratchet is in the unlatched position, the second magnitude greater than the first magnitude.

11. The vehicle latch as claimed in claim 10, wherein the second magnitude of the unlatching force exerted by the lever upon the striker is at least as large as a force exerted upon the lever by the striker.

12. The vehicle latch as claimed in claim 10, wherein the ratchet and lever are pivotable about a common axis.

13. The vehicle latch as claimed in claim 10, wherein the ratchet and lever are coupled to a common pivot.

14. The vehicle latch as claimed in claim 10, wherein:
the lever has a range of motion; and
the lever is pivotable substantially independently of the ratchet in at least a portion of the range of motion of the lever.

15. The vehicle latch as claimed in claim 10, wherein the lever is pivotable to a position in which the striker is removed from an opening in the ratchet.

16. (canceled)

17. The vehicle latch as claimed in claim 10, wherein the lever is biased by a spring.

18. The vehicle latch as claimed in claim 17, wherein the spring produces a torque on the lever, the torque having a first magnitude with the latch in an unlatched state and a second magnitude less than the first magnitude with the latch in a latched state.

19. The vehicle latch as claimed in claim 17, wherein:
the spring produces a force on the lever with the latch in a latched state and an unlatched state;
the force in both states of the latch has a radial component and a tangential component with respect to the lever; and
the tangential component of the force in the unlatched state of the latch is greater than the tangential component of the force in the latched state of the latch.

20. A vehicle latch for releasably securing a striker with respect to the latch, the latch comprising:
a ratchet having a latched position in which movement of the striker is restricted by the ratchet and an unlatched position in which the striker is removable from the ratchet;
a lever pivotable with respect to the ratchet, the lever engagable with the striker and pivotable to bias the striker toward a disengaged position with respect to the ratchet in the unlatched position of the ratchet, the lever having a first position when the latch is in a latched state and a second position when the latch is in an unlatched state; and
a spring coupled to the lever and positioned to exert a varying torque on the lever at different positions of the lever, the torque having a first magnitude when the lever is in the first position and a second magnitude with the lever in the second position, wherein the first magnitude is smaller than the second magnitude.

21. The vehicle latch as claimed in claim 20, wherein the ratchet and lever are pivotably coupled to a frame about a common axis.

22. The vehicle latch as claimed in claim 20, wherein the ratchet and lever are pivotably coupled to a frame about a common pivot.

23. A method of unlatching a vehicle latch from a striker, comprising:
applying a first force to a pivotable lever when the latch is in a latched state, the first force having a radial component and a tangential component with respect to an axis about which the lever is pivotable;
disengaging a pawl from a ratchet;
moving the ratchet from a latched position in which the ratchet restricts removal of the striker from the vehicle latch toward an unlatched state in which the striker is removable from vehicle latch;
pivoting the lever;
moving the striker with respect to the ratchet by pivoting the lever; and
applying a second force to the lever when the latch is in an unlatched state, the second force having a radial component and a tangential component with respect to the axis, wherein the tangential component of the second force is greater than the tangential component of the first force.

24. The method as claimed in claim 23, further comprising moving the striker with the lever from a first distance with respect to the axis to a second distance greater than the first distance with respect to the axis.

25. The method as claimed in claim 23, further comprising biasing the lever with a spring, wherein at least part of the first force and the second force is generated by the spring.

26. The method as claimed in claim 23, wherein moving the ratchet comprises pivoting the ratchet, the method further comprising pivoting the lever through a different range of motion than the ratchet.

27. The method as claimed in claim 23, further comprising exerting a first torque on the lever with the tangential component of the first force and creating a second torque on the lever with the tangential component of the second force, the second torque being greater than the first torque.

28. A method of unlatching a vehicle latch from a striker to release a portion of a closure panel of a vehicle from the vehicle, the method comprising:
applying a torque to a lever while the latch is in a latched state;
disengaging a pawl from a ratchet;
pivoting the ratchet about a pivot from a latched position in which the ratchet restricts removal of the striker from the vehicle latch toward an unlatched position in which the striker is removable from the ratchet;
pivoting the lever in a first direction after disengaging the pawl from the ratchet;
increasing the torque on the lever as the lever pivots in the first direction; and
moving the striker with the lever from a first distance with respect to the pivot to a second distance greater than the first distance with respect to the pivot.

29. The method as claimed in claim 28, further comprising removing the striker from the ratchet with the lever.

30. The method as claimed in claim 28, further comprising biasing the lever with a spring to generate the torque.

31. The method as claimed in claim 28, further comprising pivoting the lever through a different range of motion than the ratchet.

32. A method of releasably securing a striker with respect to a vehicle latch to releasably secure a closure panel of the vehicle to the vehicle, the vehicle latch having an unlatched state in which the striker is insertable into the vehicle latch and a latched state in which a ratchet restricts removal of the striker from the vehicle latch, the method comprising:
exerting a force upon a lever by the striker while the vehicle latch is in the unlatched state;
moving the striker towards a latched position of the striker;
moving the lever towards a latched position of the lever by moving the striker;
pivoting the ratchet from an unlatched position of the ratchet to a latched position of the ratchet; and
decreasing a resistance force exerted upon the striker by the lever as the striker is moved toward the latched position of the striker.

33. The method as claimed in claim 32, further comprising:
inserting the striker into an aperture of the ratchet;
contacting the ratchet with the striker; and
securing the striker against release from the aperture.

34. The method as claimed in claim 32, further comprising:
engaging the ratchet with a pawl; and
preventing the ratchet from pivoting to the unlatched position of the ratchet with the pawl.

35. The method as claimed in claim 32, further comprising biasing the lever against movement by the striker.
